(19) United States
(12) Patent Application Publication
(10) Pub. No.: US 2004/0042623 A1
(43) Pub. Date: Mar. 4, 2004

(54) Modular bezel design for an automotive entertainment system

(76) Inventors: Thomas Allan Zapalski, Canton, MI (US); Jeffrey Dean Luke, Wayne, MI (US)

Correspondence Address: BRINKS HOFER GILSON & LIONE, P.O. BOX 10395, CHICAGO, IL, 60611, US

(21) Appl. No.: 10/229,731

(22) Filed: Aug. 28, 2002

(51) Int. Cl. H04B 1/00

(52) U.S. Cl. 381/86

(57) ABSTRACT

The present invention is generally directed towards an entertainment system installed in an interior of a motor vehicle. The entertainment system comprises a housing and a bezel assembly attached to the housing. The bezel assembly comprises a control panel and a front panel. The control panel includes features to mount various electronic components. The features include a guide for inserting an optical disc. A plurality of control mounts to mount controls. The front panel has corresponding openings to access the features mounted on the control panel by the occupant of the vehicle.

### TECHNICAL FIELD OF THE INVENTION

This invention generally relates to an entertainment system installed in a motor vehicle. More specifically to a two-piece bezel assembly installed in the entertainment system of the motor vehicle.

### BACKGROUND OF THE INVENTION

Today's automobiles come with complete entertainment systems installed in them. Current entertainment systems are generally designed and manufactured separately according to the particular features available on a specific model. Existing radio bezels exhibit considerable complexity to account for different functions and to meet various market requirements. A given base model of radio may have several design derivatives that have unique features associated with the buttons to implement different features such as clock versions, digital signal processing (DSP) features, noise reduction, etc. These features require unique plastic bezel assemblies with the associated button differences.

Referring to FIG. 1, a typical bezel assembly installed in an interior of an automobile is shown and designated by reference numeral 200. As seen, the bezel assembly 200 comprises a front panel 210 and a back panel 212. In order to mount the buttons 214 to implement different features or functions, the back side 211 of the front panel 210 is provided with a plurality of button mounts 216. These button mounts 216 are unique to the kind of control buttons 214 used in a bezel assembly 200. Therefore, in case a customer or a car manufacturer desires a different size and shape control button, it would essentially require retooling of the entire bezel assembly. Additionally, due to packaging of the bezel assembly, the control buttons may only be mounted to the back 211 of the front panel 210. This limits the number of control buttons 214 that may be mounted to the bezel assembly 200.

Yet another drawback of the prior art is that since the front panel 214 is the Class A surface, manufacturing the front panel with the button mounts is expensive. Additionally, during the manufacturing of the front panel, each button mount may cause surface flaw that is very expensive to fix.

Consequently, in order to reduce costs and tooling time of the bezel assembly, it is highly desirable to utilize a common back panel for all radio models in a given product family, with only front panel variations.

### SUMMARY

In accordance with one of the preferred embodiments of the present invention, a bezel assembly is provided for an entertainment system. The bezel assembly comprises a control panel and a front panel.

In the preferred embodiment, the control panel is provided with multiple mounting features for mounting various electronic components. The control panel includes an optical disc guide for receiving a DVD, CD or a MP3 disc. The control panel further includes mounting points for mounting controls. The front panel is provided with corresponding holes such that the controls can be operated by the occupant of the motor vehicle. In the preferred embodiment, the size and the shape of the holes on the front panel correspond to the size and shape of the controls.

### BRIEF DESCRIPTION OF THE DRAWINGS

Further features and advantages of the invention will become apparent from the following discussion and the accompanying drawings in which:

FIG. 1 is a exploded view of the back of the front panel and the back panel of a bezel assembly according to the prior art;

FIG. 2 is a perspective view of an interior of a motor vehicle incorporating the bezel assembly in accordance with the teachings of the present invention;

FIG. 3 is a perspective view showing that two illustrative bezel assemblies in accordance with the teachings of the present invention, capable of being assembled to create the entertainment system;

FIG. 4 is an front exploded view of a bezel assembly, in accordance with the teachings of the present invention;

FIG. 5 is an back exploded view of a bezel assembly, seen in FIG. 4;

FIG. 6 is a perspective view of the bezel assembly, seen in FIG. 4 as assembled, in accordance with the teachings of the present invention; and

FIG. 7 is a second embodiment of a bezel assembly in accordance with the teachings of the present invention.

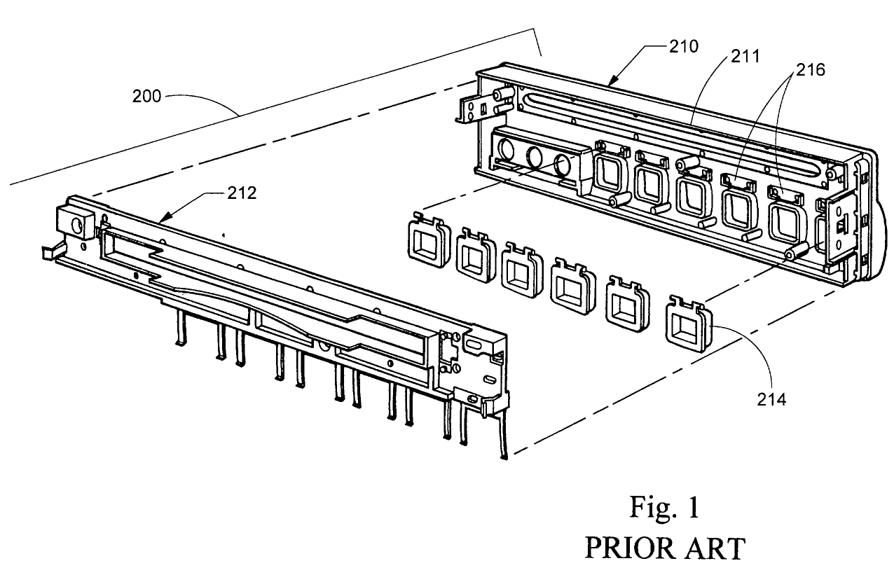

### DETAILED DESCRIPTION

The following description of the preferred embodiment is merely exemplary in nature and is in no way intended to limit the invention or its application or uses.

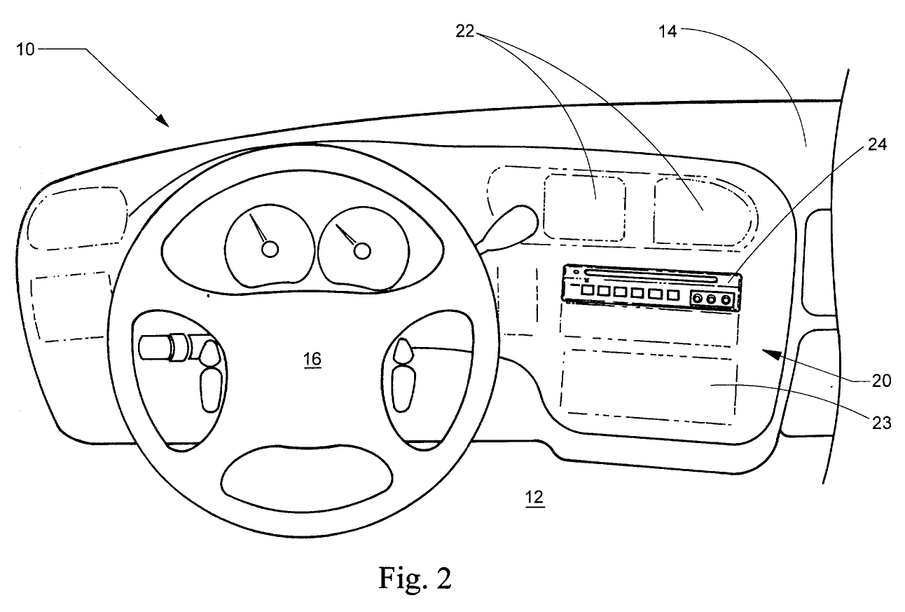

A representative motor vehicle incorporating the features of the present invention is shown in FIG. 2 and generally designated by referenced number 10. The motor vehicle's interior compartment 12 includes an instrument panel 14. The instrument panel 14 is generally installed in the vicinity of and beneath a windshield (not shown) in the motor vehicle 10. The instrument panel 14, which functions to incorporate a number of controls easily accessible to an occupant of a motor vehicle, typically comprises a steering wheel system 16 installed in the driver side, a glove compartment (not shown) installed in the passenger side of the motor vehicle 10 and a central console 20.

The central console 20 typically includes a plurality of controls easily accessible to an occupant of the motor vehicle 10 to adjust a number of user options provided in any motor vehicle. Typically such controls include an HVAC ventilation 22, a display unit 23 associated with the HVAC system for displaying the temperature of the interior of the motor vehicle and/or the temperature outside the motor vehicle, the intensity or the speed of the blower unit and other features such as time and the distance traveled by the motor vehicle 10. The central console 20 also includes an entertainment system 24. The central console 20 may or may not include all of the above features. Typically, the central console 20 is an integral part of the instrument panel 14 although it is possible to make the central console 20 modular and separate from the instrument panel 14.

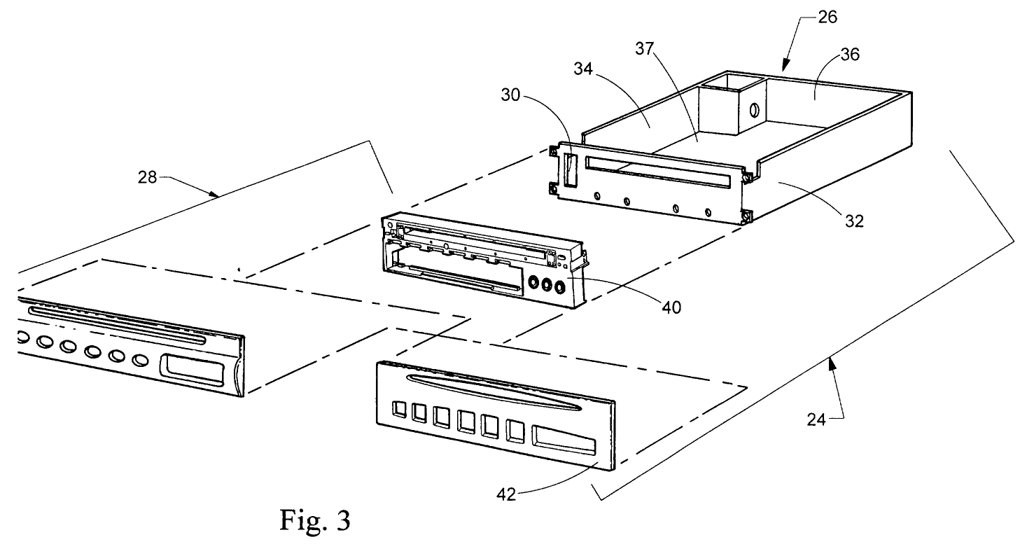

Referring in particular to FIG. 3, the entertainment system 24 comprises a housing 26 and a bezel assembly 28 attached to the housing 26. The housing 26 is fixedly attached to the central console 20 and is preferably nested in a cavity (not shown) provided in the central console 20. Alternatively, the housing 26 can be an integral part of the central console 20 or the housing 26 can be a stand alone unit sold separately from the instrument panel. In the preferred embodiment the housing 26 located therein a control assembly comprising a main micro-processor (not shown) and other micro-controller chips (not shown) and devices to implement the audio and video functions of the entertainment system 24. The housing 26 also includes a bezel connector 30 so as to electrically connect the bezel assembly 28 to the housing 26. The housing 26 is connected to a speaker unit (not shown). Preferably, the housing 26 is also connected to a navigation system (not shown) and an external antenna (not shown) typically present in any motor vehicle.

With continued reference to FIG. 3, the housing 26 is rectangular in shape and comprises sides 32 and 34, that are parallel to each other. The rear ends of the sides 32 and 34 are connected by a back plate 36. As described herein, the back and front of the housing 26 are with reference to the occupant in the vehicle, the front facing the occupant. In order to protect the electronic therein from external elements, the housing 26 may be provided with a top (not shown) and bottom 37. As discussed above, the housing 26 is located inside a cavity provided in the central console 20 such that the housing 26 is horizontally oriented. The bezel assembly 28 is attached between the sides 32 and 34 of the housing 26 such that the bezel assembly 28 is located on a front plate 38 of the housing, substantially parallel to the back plate 36.

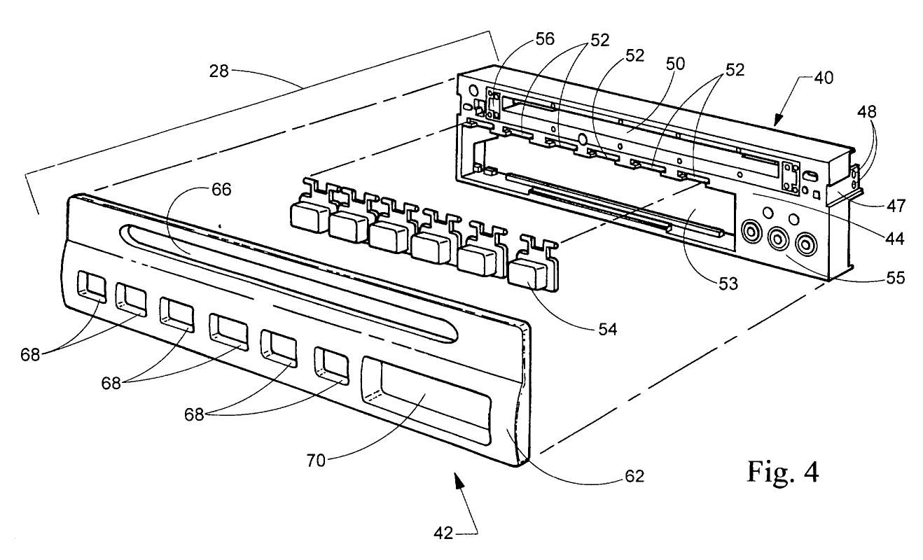

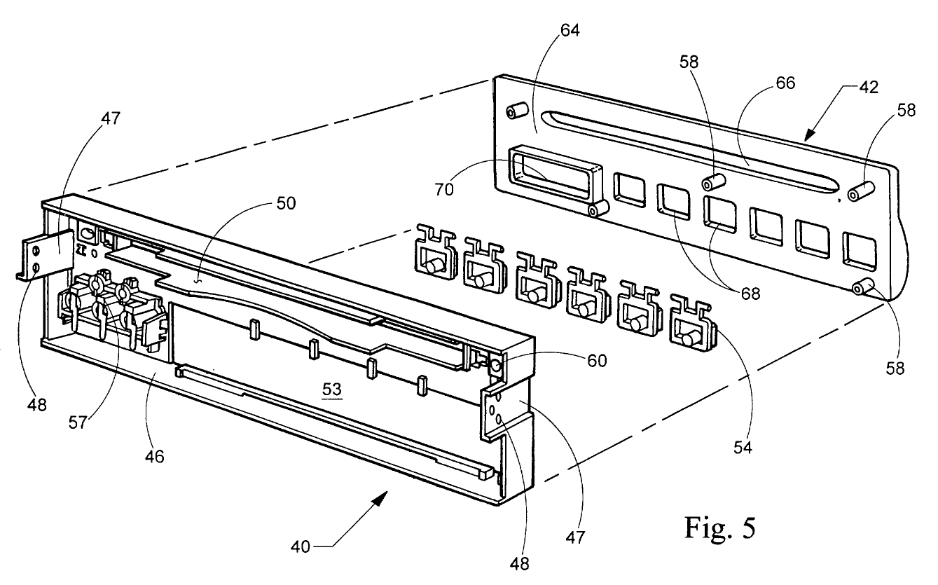

As seen in FIGS. 3, 4 and 5, the bezel assembly 28 is preferably of a two piece construction and comprises a control panel 40 and a front panel 42. The front panel 42 is attached to the control panel 40. The control panel 40 typically functions as a vehicle interface unit between the vehicular occupant and the electronics located within the housing 26. As shown, the control panel 40 with reference to the vehicular occupant has a front face 44 (shown in FIG. 4) and a back face 46 (as shown in FIG. 5) facing the housing 26. In order to mount the control panel 40 to the housing 26, the control panel 40 preferably has a housing mount 47 extending generally off of and preferably perpendicular from the back face 46 of the control panel. As shown, the housing mount 47 has a plurality of openings 48 to insert a fastener, screw or other means to attach the control panel 40 to the housing 26. Alternatively, the control panel 40 and the housing 26 can be provided with fasteners enabling a snap fit construction such that the control panel 40 is snap fitted into the housing 26. Preferably, the control panel 40 is made of plastic and is formed by an injection molding process. Alternatively, the control panel 40 may be formed of metal or other materials formed by other processes. While it is preferred that the control panel 40 is formed as a separate piece removable from the housing 26, it may be formed as an integral or a unitary part of the housing 26.

With reference to FIGS. 4 and 5, the control panel 40 has a plurality of features associated with it to allow the entertainment system to perform its functions. As shown in the figures, the control panel 40 has a guide slot 50 for inserting an optical disc such as a DVD/CD/MP3 disc. The control panel 40 also has a rectangular cut-out 53 extending horizontally across the control panel 40. A plurality of control mounts 52 are positioned immediately above the cut-out 53. The control mounts 52 are used to mount controls 54 to the control panel 40 such that they align in front of the cut-out 53. The control mounts 52 are preferably formed by a “T-shaped” recess 49 defined on the front face 44 of the control panel 40. The recess 49 interact with the pivots 51 formed on the controls 54 so as to retain the pivots 51 within the recess 49. Alternatively, the control mounts 52 may be formed on both the front face 44 and the back face 46 of the control panel 40. These controls 54 are capable of performing pre-defined functions when electrically connected through a circuit board to the electronics located within the housing 26. The pre-defined functions may include volume control, fast forwarding, rewind functions, etc. Preferably, the plurality of controls 54 is in form of hinge button (as shown). Alternatively, the plurality of controls 54 can be in form of push buttons or touch pad. The plurality of controls 54 can be of different size and shape depending on the preference of the motor vehicle manufacturer or the vehicular occupant. For example, it is possible to have the controls 54 that have a circular shape, a rectangular shape or an oval shape. It must be understood that these shapes are only listed as an example and do not prevent other shapes that the controls 54 may have. The size and shape of the controls 54 are only for aesthetic purpose and does not affect the function of the control panel 40 or the entertainment system 24.

The front face 44 of the control panel 40 also includes a socket 56 near the guide slot 50 for inserting lights or jewels capable of illuminating the guide slot 50 in the dark. The lights used in the invention are LED lights and are well known in the art and therefore are not explained in detail. In order for the control panel 40 to perform a video function, the control panel 40 is provided with an Audio/Video input/output socket 55 adjacent to the cut-out 53. The socket 55 is connected to the electronics located inside the housing 26 with the help of connecting pins 57.

In order to operate the control panel 40, the control panel 40 is connected to a circuit board (not shown). A pre-defined circuit is etched to the circuit board and the controls 54 are operatively connected to the circuit board. The circuit board is connected to the bezel connector 30 on the front plate 38 of the housing 26. Therefore, when the occupant of the vehicle operates the button, they press against the circuit board, thereby performing the pre-defined function.

With continued reference to FIGS. 4 and 5, the front panel 42 of the bezel assembly 28 is attachable to the control panel 40. The front panel 40 is flush with the central console 20 of the instrument panel 14 such that the front panel 42 adds to the aesthetic appearance of the interior 12 of the motor vehicle. The front panel 42 of the bezel assembly 28 also functions as a Class A surface. Alternatively, it is also possible that the control panel 40 is protruding outwards towards the occupants such that the front panel 42 is not flush with the central console 20. The preference of whether the front panel 42 is flush with the central console 20 or is protruding outside the central console 20 is a matter of aesthetics and will not affect the function or the use of the control panel 40. Preferably, the front panel 40 is formed of plastic by an injection molding process. Alternatively, it may be formed of metal, wood composite or any other any material capable of functioning as a Class A surface by an other process.

As seen in FIGS. 4, 5 and 6, the front panel 42 is attached to the front face 44 of the control panel 40 and is separate from the control panel 40. It is also possible to design the front panel 42 such that when the front panel 42 is removed it renders the entertainment system 24 inoperable. As shown, the front panel 42 is rectangular in shape and has dimensions such that it snuggly fits onto the front face 44 of the control panel 40. Preferably, the front panel 42 has snap points 58 and the control panel 40 has corresponding holes 60, such that the front panel 42 is snap fitted to the front face 44 of the control panel 40. Alternatively, the front panel 42 may be screwed or bolted to the front face 44 of the control panel 40.

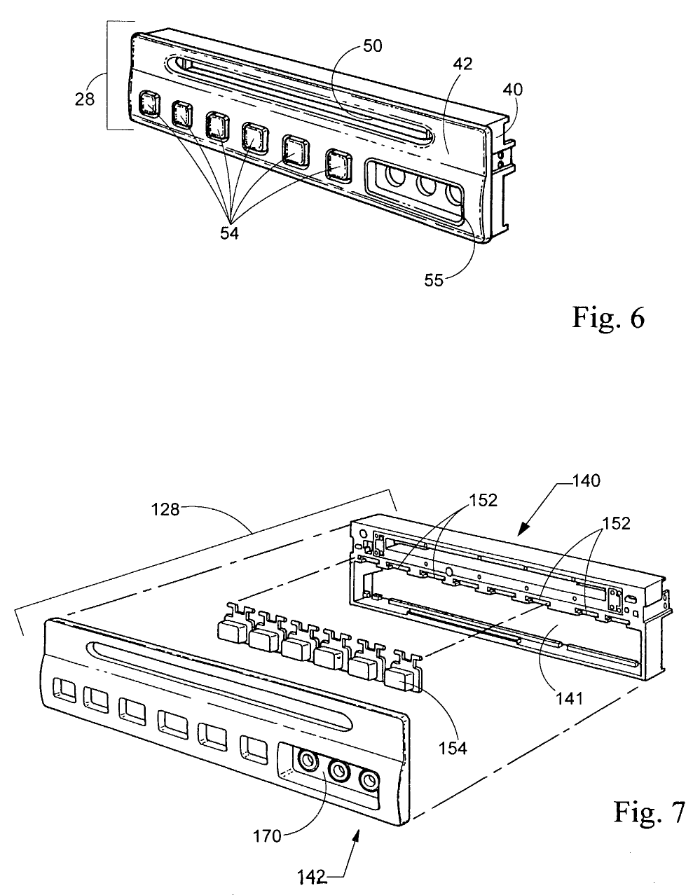

With continued reference to FIGS. 4, 5 and 6, like the control panel 40, the front panel 42 has a front face 62 (as shown in FIG. 4) and a back face 64 (as shown in FIG. 5). The front face 62 is exposed to the vehicular occupant and is the Class A surface. Therefore, when the control panel 40 and the front panel 42 are fitted together they give the appearance of a single unit (as shown in FIG. 6).

With continued reference to FIGS. 4, 5, and 6, the front panel 42 defines a number opening corresponding to the features in the control panel 40 to enable the occupant to operate the features. As shown, opening slot 66 corresponds to the guide slot 50 in the control panel 40 for inserting an optical disc. Openings 68 correspond to the plurality of controls 54 attached to the control mounts 52 in the control panel 40. The openings 68 in the front panel 42 are designed such that the controls 54 protrude out of the opening 68 and can be operated by a occupant. The shape and size of the openings 68 on the front panel 42 correspond to the shape and size of the controls 54. For example, if the controls 54 used on the control panel 40 are oval in shape, then the openings 68 in the front panel 42 are also oval (see FIG. 3). Alternatively, if the controls 54 in the control panel 40 are rectangular, then the openings 68 on the front panel 42 are also rectangular. As shown in the drawing, the front panel 42 also includes a separate socket 70 corresponding to the AV input/output 55 on the control panel 40.

FIG. 7, represents an alternate embodiment of the bezel assembly 128. In this embodiment, the bezel assembly 128 includes a control panel 140 and a front panel 142. Like the first embodiment, the control panel has mounting points 152 for mounting controls 154. As shown, the audio video input out control is fixed on the front panel 142. The control panel 140 defines a corresponding opening 141 to receive the AV input output such that an audio/video plug can be externally connected to the AV input output 55.

The present invention provides for using a common design for the control panel 40 in different motor vehicles. Particularly, it provides for installing different entertainment systems with different features and designs at minimum tooling and designing efforts. For example, a first vehicle may be provided with a control panel 40 having circular control buttons 54. In order to create the front panel 42 corresponding to the control panel 40, a front panel 42 with circular openings 68 has to be tooled and designed. Similarly, a second vehicle may be provided with a control panel 40 having rectangular control buttons 54. In this instance, the same design of the control panel 40 can be used on the second vehicle, with only design modifications to the front panel 42. Therefore, the present invention reduces the need to design and retool the entire bezel assembly 28. Additionally, since the mounting features are present in the control panel 40, not visible to the vehicular occupant any surface flaws on the control panel 40 can be covered by attaching the front panel 42.

As any person skilled in the art will recognize from the previous description and from the figures and claims, modifications and changes can be made to the preferred embodiment of the invention without departing from the scope of the invention as defined in the following claims.

What is claimed is:

1. An entertainment system installed in an interior of a motor vehicle, wherein the entertainment system is operable by an occupant in the motor vehicle, the system comprising:
a housing adapted to be mounted in the interior of the motor vehicle; and
a bezel assembly attachable to the housing, wherein the bezel assembly comprises:
a control panel for interfacing with the housing, wherein the control panel has at least one control mount;
at least one control device mounted to the at least one control mount, wherein the at least one control device is capable of performing a predefined electronic function; and
a front panel attachable to the control panel, wherein the front panel has at least one opening corresponding to the at least one control device, to allow operation of the at least one control device by the occupant.

2. The system of claim 1, wherein the control panel further comprises a mounting guide for inserting an optical disc.

3. The system of claim 2, wherein the front panel further comprises an opening corresponding to the mounting guide such that the optical disc can be inserted by the occupant.

4. The system of claim 1, wherein the control panel further comprises a socket for attaching a self-illuminating light.

5. The system of claim 1, wherein the control panel further comprises an Audio/Video input/output socket.

6. The system of claim 5, wherein the front panel comprises an opening corresponding to the audio/video input/output socket.

7. The system of claim 1, wherein the at least one control device is operatively connected to a circuit board to perform the pre-defined electronic function.

8. The system of claim 1, wherein the front panel comprises an audio/video input/output socket.

9. The system of claim 1, wherein the at least one control device is selected from a group consisting of hinge buttons, push buttons or touch pad.

10. The system of claim 1, wherein the front panel is a Class A surface.

11. The system of claim 1, wherein the at least one control mount in control panel has a recess to receive the at least one control device.

12. The system of claim 1, wherein the front panel is formed of plastic, metal or wood.

13. The system of claim 1, wherein the control panel is formed of plastic or metal.

14. A bezel assembly attached to a housing in an entertainment system installed in an interior of a motor vehicle, the assembly comprising:
a control panel for interfacing with the housing, wherein the control panel has at least one control mount;
at least one control device mounted to the at least one control mount, wherein the at least one control device is capable of performing a predefined electronic function; and
a front panel attachable to the control panel, wherein the front panel has at least one opening corresponding to the at least one control device, to allow operation of the at least one control device by the occupant.

15. The assembly of claim 14, wherein the control panel further comprises a mounting guide for inserting an optical disc.

16. The assembly of claim 15, wherein the front panel further comprises an opening corresponding to the mounting guide such that the optical disc can be inserted by the occupant.

17. The assembly of claim 14, wherein the control panel further comprises a socket for inserting self-illuminating light.

18. The assembly of claim 14, wherein the control panel further comprises an Audio/Video input/output socket.

19. The assembly of claim 18, wherein the front panel comprises an opening corresponding to the audio/video input/output socket.

20. The assembly of claim 14, wherein the at least one control device is operatively connected to a circuit board to perform the pre-defined functions.

21. The system of claim 14, wherein the front panel comprises an audio/video input/output socket.

22. The assembly of claim 14, wherein the at least one control device is selected from a group consisting of hinge buttons, push buttons or touch pad.

23. The assembly of claim 14, wherein the front panel is a Class A surface.

24. The system of claim 14, wherein the at least one control mount in control panel has a recess to receive the at least one control device.

25. The assembly of claim 14, wherein the control panel is formed of plastic or metal.

26. The assembly of claim 14, wherein the front panel is formed of plastic, metal or wood.

27. A method of installing a first entertainment system for a first vehicle and a second entertainment system for a second vehicle, the method comprising:
providing a set of housings, each fastenable to the first vehicle and the second vehicle;
providing a set of control panels having mounting features, each fastenable to the one of housings;
providing a first front panel having openings corresponding to the mounting features, fastenable to one of the control panels;
providing a second front panel having openings corresponding to the mounting features, fastenable to one of the control panels;
installing one of the housings, one of the control panels and the first front panel in the first vehicle;
installing one of the housings, one of the control panels and the second front panel in the second vehicle.

28. The method of claim 27, wherein the mounting features comprises:
a mounting guide;
a mounting mount; and
a controls mounted on the mounting mount for performing a pre-defined function.
